(19) United States
(12) Patent Application Publication
(10) Pub. No.: US 2012/0233300 A1
(43) Pub. Date: Sep. 13, 2012

(54) CONFIGURING CONNECTION AGENTS

(75) Inventors: Luis G. Marmolejo-Meillon, San Jose, CA (US); Barbara Nelson, San Mateo, CA (US)

(73) Assignee: iPass Inc., Redwood Shores, CA (US)

(21) Appl. No.: 13/348,633

(22) Filed: Jan. 11, 2012

Related U.S. Application Data
(60) Provisional application No. 61/431,815, filed on Jan. 11, 2011.
(60) Provisional application No. 61/431,836, filed on Jan. 11, 2011.

(51) Int. Cl. G06F 15/177

(52) U.S. Cl. 709/221

(57) ABSTRACT

In some embodiments, a method includes detecting, in a connection agent, a problem connecting to a network; receiving, in the connection agent, replacement configuration options, wherein the replacement configuration options are for updating a configuration profile for the connection agent; wherein the configuration profile for the connection agent and the replacement configuration options define parameter values used in connecting to a network; updating the configuration profile for the connection agent based on the replacement configuration options; and determining, using testing components in the connection agent, test results that indicate the replacement configuration options do not solve the problem connecting to the network.

### RELATED APPLICATIONS

This application claims priority benefit of U.S. Provisional Application 61/431,836 filed Jan.11, 2011. This application also claims priority benefit of U.S. Provisional Application 61/431,815 filed Jan. 11, 2011.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2012, iPass Inc.

### FIELD

Some embodiments of the inventive subject matter relate generally to the field of software configuration, and some embodiments relate more particularly to configuring connection agents that connect computing devices to networks.

### BACKGROUND

In today's computing environment, there are many broadband networks, such as free networks, enterprise networks, public hotspots, hotel broadband networks, home networks, etc. Because of the multitude of available networks, users need network connection agents capable of connecting to multiple networks. In some instances, traveling users need access to networks over wide geographic areas. Thus, network connection agents must be robust and flexible.

When operating in the field, network connection agents may encounter problems. For example, users roaming in foreign countries may encounter problems connecting to remote networks. Such problems may be resolved by testing, changing configuration options in the network connection agents, and other solutions.

### BRIEF DESCRIPTION OF THE FIGURES

The present invention is illustrated by way of example and not limitation in the Figures of the accompanying drawings in which:

FIG. 1 shows how some embodiments select, test, and distribute configuration options.

FIG. 2 is a block diagram illustrating a system in which connection agents connect computing devices to networks, according to some embodiments of the invention.

FIG. 3 is a block diagram illustrating a connection agent, according to some embodiments of the invention.

FIG. 4 is a flow diagram illustrating operations for receiving configuration options from a user, according to some embodiments of the invention.

FIG. 5 describes components and operations for activating tests, according to some embodiments of the inventive subject matter.

FIG. 6 is a block diagram showing event-triggered logging, as performed by some embodiments of the inventive subject matter.

FIG. 7 is a block diagram illustrating a process for logging, according to some embodiments of the inventive subject matter.

FIG. 8 is a block diagram of a data model used in connection with some embodiments.

FIG. 9 is a diagram showing a CCL list for one test and currently with two entries (CC1 and CC2).

FIG. 10 shows an alternative architecture, according to some embodiments.

FIG. 11 shows an architecture of the

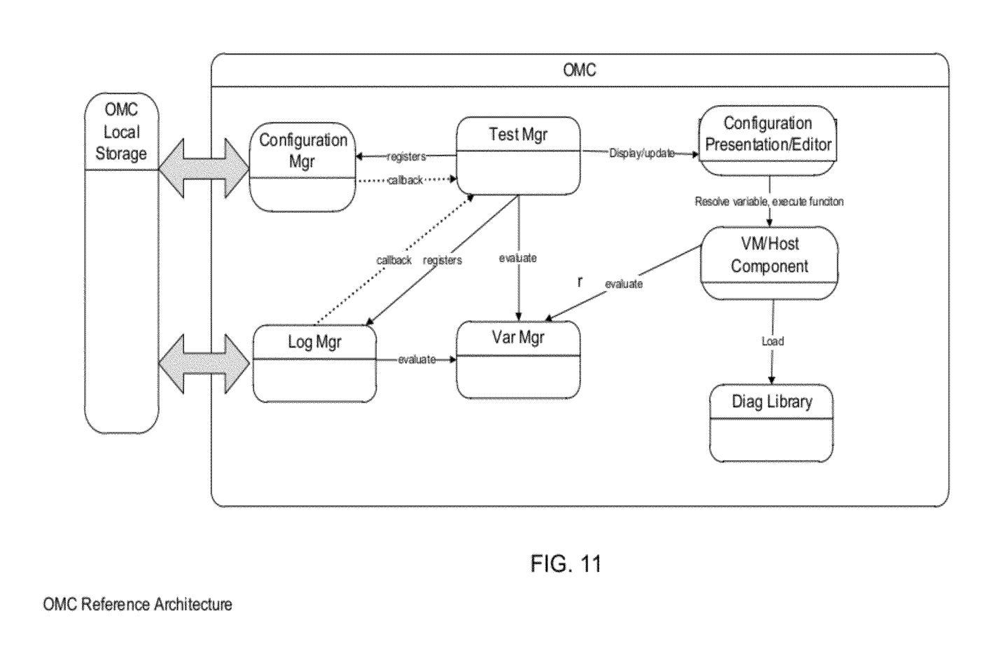

### DESCRIPTION OF THE EMBODIMENTS

This document includes techniques for configuring, testing, logging, and otherwise operating network connection agents.

### Introduction

Many computing devices (e.g., laptop computers, personal digital assistants, mobile media devices, etc.) connect to networks to access data, software, and services. These computing devices often include network connection agents that detect available networks, facilitate network selection, and connect to selected networks.

Some connectivity providers have large numbers of network connection agents in the field. As the total number of provisioned applications, provisioned elements (i.e., features), unique configuration profiles, or targeted users increases, so does management complexity. Mistakes or omissions in profile options, or in the sequence of modify, deploy, test, verify, and re-test, generally results in poor user experiences (e.g., unavailable applications, sub-optimal performance, inoperable features, decreased reliability and productivity, etc.). As network connection agents exhibit problems in the field, administrators may modify configuration options to remedy the problems. Some systems include a web service through which administrators can modify configuration options for a configuration profile (hereinafter “profile”). The system saves the modified profile, and distributes the modified profile to connection agents having that profile. After the modified profile reaches connection agents in the field, users can test the modified profile. If the modified profile remedies the problems, the process is successful. However, if the modified profile does not remedy the problems, administrators must repeat the process. Because testing is done after modified profiles are distributed, the modified profile may accidentally adversely affect all network connection agents in the profile. That is, the modified profile may include errors that affect connection agents that were not exhibiting problems (e.g., because those connection agents were exposed to conditions causing the problems, such as roaming outside a connection area).

Some embodiments of the inventive subject matter enable selection, use, and testing of configuration options on a small number of connection agents. That is, some embodiments enable administrators to modify configuration options on a limited number of connection agents before widely distributing the modified configurations.

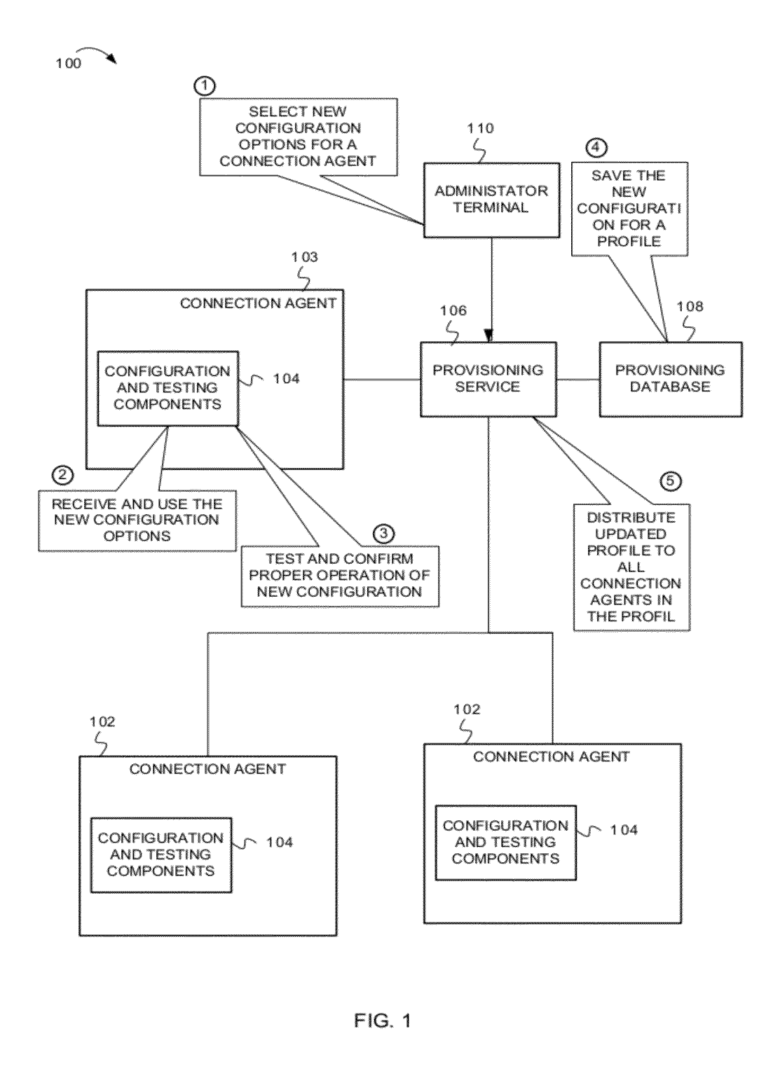

FIG. 1 shows how some embodiments select, test, and distribute configuration options. In FIG. 1, a system 100 includes network connection agents (hereinafter “connection agents”) 102 & 103, administrator terminal 110, provisioning service 106, and a provisioning database 108. As shown, the connection agents 102 & 103 include configuration and testing components 104, which provide functionality for modifying configuration options, testing modified configurations, and distributing modified configurations to other connection agents 102. In some embodiments, the configuration and testing components 104 include a database of all possible configuration options, and a test suite for performing numerous tests (e.g., tests that determine whether a connection agent operates properly with a given configuration). Although not shown, the connection agents 102 & 103 reside on computing devices, such as a laptop computers, mobile phones, etc.

The provisioning service 106 provides access to the provisioning database 108, and services for modifying and distributing modified configuration options. Administrators can access to the provisioning service 106 using the administrator terminal 110. The provisioning service 106 is accessible over a network, and can support a web-based interface (e.g., a portal) through which administrators can configure various configuration options. The provisioning database 108 includes configuration options associated with one or more profiles. FIG. 1 shows operations of the system 100 occurring in four stages.

During stage 1, an administrator selects configuration options and a connection agent 103. The configuration options can be any selectable parameters in the connection agent's profile, such as virtual private network parameters, authentication parameters for a particular network media type, etc. The administrator can select one or more agents (e.g., connection agent 103) based on user identifiers, device identifiers associated with devices on which connection agents are running, identifiers associated with the connection agents themselves, identifiers for access points to which the connection agents connect, any combination of these identifiers, features enabled on the connection agents (e.g., patches, version, profile information).

During stage 2, the connection agent 103 receives and uses the configuration options. For example, the connection agent connects to one or more networks using the configuration.

During stage 3, the connection agent's configuration testing components 104 test and confirm proper operation of the new configuration. The testing may be automated, semi-automated, or manual. For example, an automated test may determine whether a network connection was successful by probing a well-known Internet address, such as www.google.com. If the test probe gets a response, it is the network connection was successful. For a semi-automated test, the connection agent may ask a user to confirm information about the network connection. For example, the connection agent may ask the user whether certain graphics or other information appeared in a graphical user interface. Based on the user's response, the test determines whether the configuration operates properly. For manual testing, the user may gather various information and entered into the connection agent 103 or send it to the provisioning service 106. After performing the testing, the connection agent 103 can provides test results, program execution traces, and any suitable information to the administrator via the provisioning service 106.

During stage 4, the administrator determines the new configuration options operate properly, and saves them to a profile in the provisioning database 108. The administrator terminal 110 and provisioning service 106 facilitate the operations of stage 4. During stage 5, the administrator, via the provisioning service 106, distributes the updated profile to other connection agents 102 in the field.

Because the connection agents 102 & 103 themselves can test configuration options, they can quickly remedy many problems. If new configuration options do not work properly, Administrators can quickly select and test different configuration options. Additionally, because configuration changes are limited to a small number of connection agents (e.g., one connection agent), some embodiments avoid scenarios where modified configurations cause problems on otherwise unaffected connection agents. After the modified profile is saved in the provisioning database 108, it is subject to a profile change management life cycle. For example: the changes can be immediately accepted and deployed for production or can be further reviewed, edited and tested before production deployment. The profile change management cycle is driven by administrators and implemented by the provisioning service 106.

Although different from FIG. 1, the connection agent 103 may receive the new configuration options as user input without connecting to the provisioning service 106. For example, a user can enter parameters needed for establishing a virtual private network (VPN). In yet other embodiments, the connection agent 103 can receive some configuration options from the provisioning service 106, while receiving others as user input to the connection agent 103.

Although not shown in FIG. 1, the connection agent 102 & 103 can reside in a computing devices, such as laptop computers mobile phones etc. Alternatively, the connection agents 102 & 103 includes computing devices.

In some embodiments, configuration options can include feature sets, features, attributes, and/or attribute values.

The following sections will provide more details about various embodiments of the inventive subject matter.

### Operating Environment and Operations

This section describes an example operating environment and provides structural aspects of some embodiments.

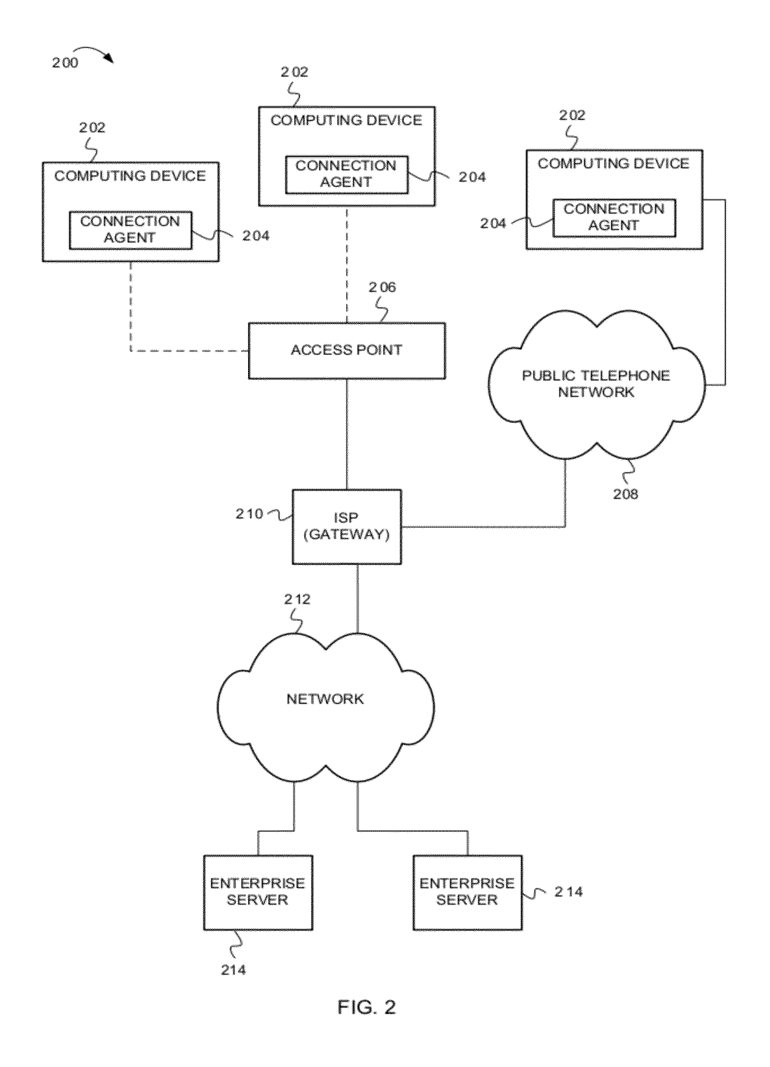

FIG. 2 is a block diagram illustrating a system in which connection agents connect computing devices to networks, according to some embodiments of the invention. In FIG. 2, a system 200 includes computing devices 202, which include connection agents 204. The system 200 also includes an access point 206, public telephone network 208, Internet service provider (ISP) 210, network 212, and enterprise servers 214.

During operation, the connection agents 204 can connect the computing devices 202 to the ISP 210, which in turn, connects the computing devices to the enterprise servers 214. The ISP 210 can also enable the computing devices 202 to communicate with devices on the Internet (not shown). Although not shown in FIG. 2, the system 200 can include a provisioning service and provisioning database (similar to that shown in FIG. 1) for facilitating configuration changes in the connection agents 204.

In some embodiments, the computing devices 202 include desktop computers, notebook computers, tablet computers, personal digital assistants, mobile telephones, mobile media devices, etc. In other embodiments, one or more of the computing devices 202 can be embedded in other systems, such as automobiles, air craft, etc.

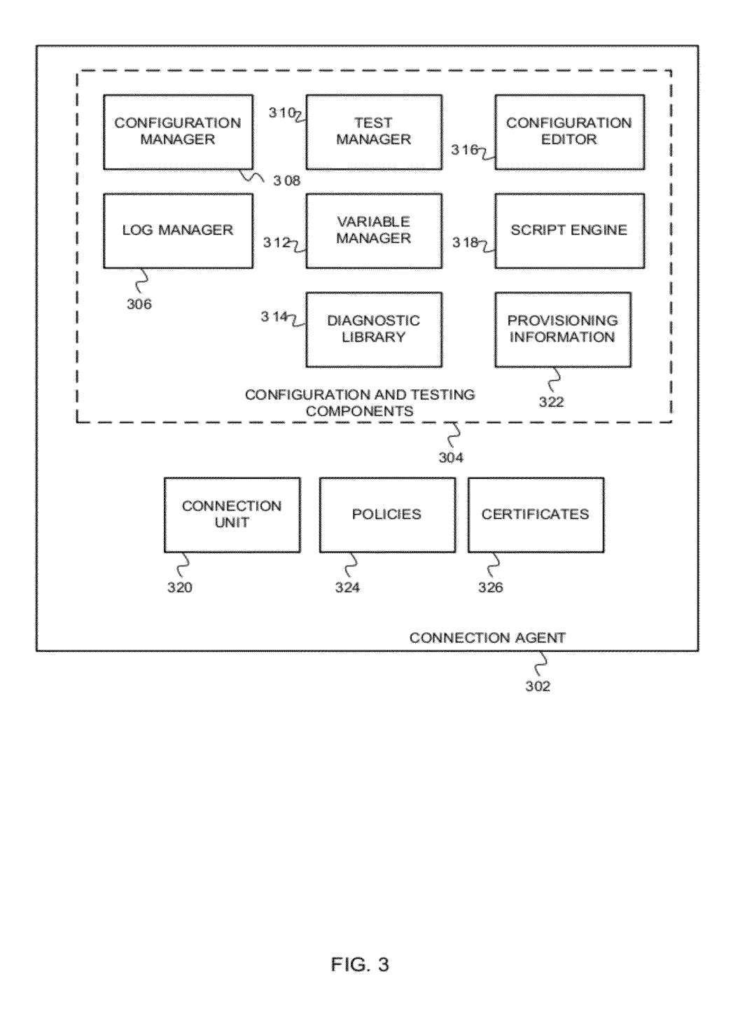

The following discussion of FIG. 3 provides more details about connection agents.

FIG. 3 is a block diagram illustrating a connection agent, according to some embodiments of the invention. In FIG. 3, the connection agent 302 includes a connection unit 320, policies 324, and certificates 326, and configuration testing components 304. The connection unit 320 includes components for establishing network connections. In some embodiments, the connection unit 320 controls network adapters, communicates data according to networking protocols, and performs other tasks necessary for connecting and exchanging data over networks. The configuration and testing components 304 include provisioning information 322. In some embodiments, the connection agent 320 configures itself based on the provisioning information 322. The provisioning information 322 can include information for configuring all components necessary for connecting and communicating over networks. For example, the provisioning information 322 can include configuration options for network adapters, authentication protocols, virtual private networks, etc. The policies 324 include security policies that govern connection behavior (e.g., prohibited networks, access rights, etc.), whereas certificates 326 include digital certificates for use by the connection unit 320.

As shown, the configuration and testing components 304 also include a configuration manager 308, test manager 310, log manager 306, variable manager 312, script engine 318, diagnostic library 214, and configuration editor 316.

The configuration manager 308 provides a single point of use for changing and controlling data in a profile. The configuration manager 308 provides an interface for reading and writing any of the named attributes (i.e., configuration options) of the profile. For example, the configuration manager 308 can support get( ) commands that read profile data and set( ) commands that support writing profile data. The configuration manager 308 can operate in test mode. When in test mode, the configuration manager notifies the test manager 310 (e.g., by an event/callback mechanism) when get/set commands fall within a registration criteria specified by the Test Manager. For example, when a get/set command touches specific profile parameters relevant to one or more specified tests, the configuration manager 308 sends an event to the test manager. The test manager 310 uses the event to determine whether a registered test script needs to be evaluated. The configuration manager 308 can send such events to the log manager, which can use the events to determine whether a log entry can be ignored. In some embodiments, the events have the following form: <caller, configuration parameter>. The caller is the component that made the get/set call to the configuration manager 308, while the configuration option refers to the configuration parameter being read/written (e.g., a Virtual Private Network parameter). Thus, the test manager 310 learns what components are reading and writing configuration information.

The test manager 310 determines tests and parameters for a current profile by querying the configuration manager 308. The test manager 310 registers with the log manager 206 to receive events indicating that components are attempting to log information. The test manager 310 also registers with the variable manager 212 and configuration manager 308 to receive events indicating that components are attempting to read/write variables and configuration options. The test manager 310 also maintains a list of configured tests, where each test has a start condition and a stop condition. The test manager 310 evaluates the start and stop conditions upon receipt of events from the variable manager 212, log manager 206, and configuration manager 308. The start condition is a Boolean expression that indicates whether a test is active (i.e., executing). The stop condition is a Boolean expression that indicates whether the test is inactive (i.e., not currently executing). When the stop condition becomes true, the test manager 310 will stop execution of the test. In some embodiments, the stop condition is a comparison expression based on the caller prefix context, named thread, service or log category. The log manager can query this result and perform a logical AND operation with it and test specific conditions defined for the test. A caller prefix context represents a call stack, all the way down to the named procedure encapsulating the place in the code where a particular function or method is called. For example (main:A:B) indicates the activation path from main program followed by a call to subroutine A, then subroutine B. Comparisons based on regular expressions allows for detecting special cases like recursion. The test manager can compare caller prefixes of the current test (i.e. the set of 1 or more get/set operations received from the configuration manager 308) against the caller prefixes of the component attempting to make the log entry. Some embodiments of the test manager 310 may perform one or more of the following:
Test scope is a named feature set, feature, or attribute.
The test manager 310 associates the attribute that triggers the notification, along with its calling context, and makes it available during evaluation of the start/stop conditions.
Registers trace test with log manager 306 (See log manager 306).
The registration request can include a within-scope condition. When this condition evaluates to true AND the test is active, then the log manager 306 will consider future log entry requests as falling within the scope of this test. The test manager will then receive the corresponding data streams.
Registers verification test with the log manager 306. See discussion of Log manager 306.
Registers diagnostic test with log manager 306. See discussion Log Manager.
Receives requests from the connection agent as to whether the named test is Completed Test-Complete method (Finished, Terminated, and Aborted). This will force the status to be set to complete regardless of the stop condition.
Test status will be updated, persisted, and if the test is configured for manual verification, also cause the user to be prompted for the outcome of the test: Pass, Fail, Or Inconclusive.
Requests the log manager to stop streaming Log Records.
The log manager 306, can stop streaming records when the scope condition is no longer met. However, the test manager can explicitly request to do so.
Keeps track of current status and history of tests performed, its corresponding output, verification outcomes, and diagnostic tests.
Interacts with the end-user to determine when it is time to revert from Test mode, the outcome of the test, the edited/final values that must be pushed back to the OMP for its incorporation into the production profile, updates the profile and test status and results to the OMP.
Uses the VAR Manager for the storage, retrieval and sharing of configuration attributes.
Manages Test specifications, trials, outcomes, synchronization with OMP.

The configuration editor 316 can enable users to view, edit, and otherwise modify configuration profiles.

The script engine 318 can execute scripts. In some instances, tests are embodied as scripts. In some instances, scripts are used for other purposes. The scripts can include high-level programming language code, machine code, or any other suitable computer code. Thus, in some instances, the script engine may act as run-time interpreter that executes the script code. In some instances, the script engine 318 results variables by accessing variable values stored in the variable manager 312.

The variable manager 312 stores and provides variable values used by any component of the connection agent. For example, the variable values may be used by scripts running on the script engine 318. Alternatively, the variable manager 312 can store variable values needed by the connection unit 320.

The diagnostic library 314 can include a number of pre-configured tests and custom-designed tests (e.g., tests written using the configuration editor 316). The pre-configured tests can include tests that test various aspects of operation, such as tests for testing operations for establishing virtual private networks, testing operations for establishing an Internet connection, testing operations of a network adapter, etc. The custom-designed tests can test any condition/operation in the connection agent 302.

The provisioning information 322 can include all configuration options needed for connecting to a network. The configuration options include parameter values used in connecting to a network. For example, the provisioning information 322 can indicate settings for network adapter, the virtual private network, username and password, and other information needed for connecting to a network. In some embodiments, the configuration manager 308 provides an interface into the provisioning information 322.

The inventive subject matter can be embodied as systems, methods, or computer program products. Accordingly, aspects of the present inventive subject matter may take the form of entirely hardware embodiments, entirely software embodiments (e.g., including firmware, resident software, micro-code, etc.), or embodiments combining software and hardware. Furthermore, aspects of the inventive subject matter may take the form of a computer program product embodied in one or more computer readable medium(s) having computer readable program code embodied thereon.

Any combination of one or more computer readable mediums may be utilized. The computer readable medium may be a computer readable signal medium or a computer readable storage medium. A computer readable storage medium may be, for example, an electronic, magnetic, optical, electromagnetic, infrared, or semiconductor system, apparatus, or device, or any suitable combination of the foregoing. More specific examples (a non-exhaustive list) of the computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), and an optical storage device, a magnetic storage device. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

This description continues with a discussion of connection agents capable of receiving configuration options from a user, using the configuration to connect to a network, and transmitting the configuration back to a configuration service for use by other configuration agents. Such a configuration lifecycle differs from the typical way configuration options are disseminated among configuration agents. Typically, configuration options are selected by and administrator (e.g., at administrator terminal 110) and provisioned by a provisioning service (e.g., see 106), which transmits the configuration to a large number of connection agents operating in the field. However, administrators may be geographically separated from a particular network that is available to some connection agents. Therefore, embodiments enable users, who are geographically proximate to the network, to change configuration settings. If those configuration settings were properly, the provisioning system can deploy those configuration settings to other configuration agents that may want to connect to the network.

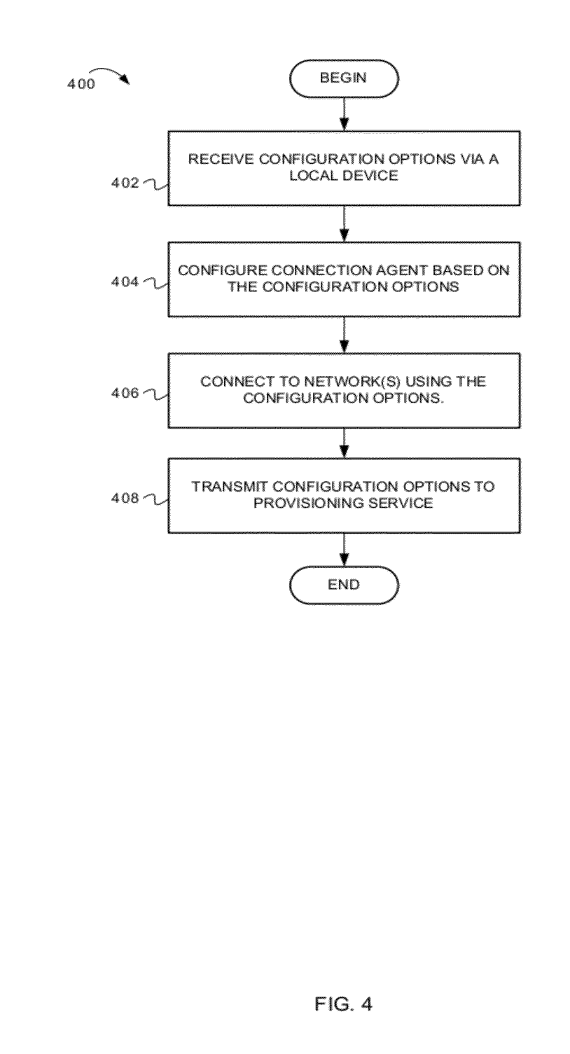

FIG. 4 is a flow diagram illustrating operations for receiving configuration options from a user, according to some embodiments of the invention. The flow 400 begins at block 402, where a configuration agent receives configuration options via a local device. For example, configuration agent presents a graphical user interface through which it receives user-selected configuration options, such as security settings, protocol settings, or any suitable configuration option. The flow continues at 404.

At block 404, the connection agent configures itself based on the configuration options received via the graphical user interface. At block 406, the connection agent connects to a network using the configuration options. For example, the connection agent connects to a Wi-Fi network using protocols, security certificates, passwords, and/or other information included in the configuration options that were received at block 402. At block 408, after a successful connection to the network, the connection agent transmits the configuration options to a provisioning service.

After the provisioning service receives the configuration settings, it can deploy the configuration to certain connection agents in the field, such as connection agents that may connect to a network for which the configuration applies. For example, if the configuration is useful for connecting to a network in Germany, the provisioning service can deploy the configuration to connection agents that may connect to the German network.

### More About Testing and Logging

In the past, some connection agents perform logging and testing in ways that excessively consume system resources and produce volumes of data. For example, in an attempt to diagnose a connection problem, some connection agents may run tests and log information over an arbitrary time period. During most of the time period, the connection agent may not be performing tasks relevant to the tests. As a result, the tests may consume system resources and log large volumes of test data, which can overwhelm and confuse technicians who are trying to solve configuration issues. Some embodiments of the inventive subject matter reduce the amount of testing and test data by employing an event-driven testing and logging mechanism that executes tests and logs information at relevant times. For example, in some embodiments, the event-driven mechanism activates tests only after particular parameters or features have been read or modified. Additionally, the event-driven mechanism may reduce the volume of test data by logging test data only for parameters and/or features that within scope for an active test. As a result, embodiments are more strategic about initiating tests and logging test data.

In some embodiments, the tests described herein determine whether a connection agent works with a given configuration. That is, some tests are not testing whether the connection agent's code is working properly. Instead, some tests determine whether a given the connection agent can operate properly (e.g., connect to a particular network) with a given configuration. The tests log certain information, and send information back to the provisioning service for analysis.

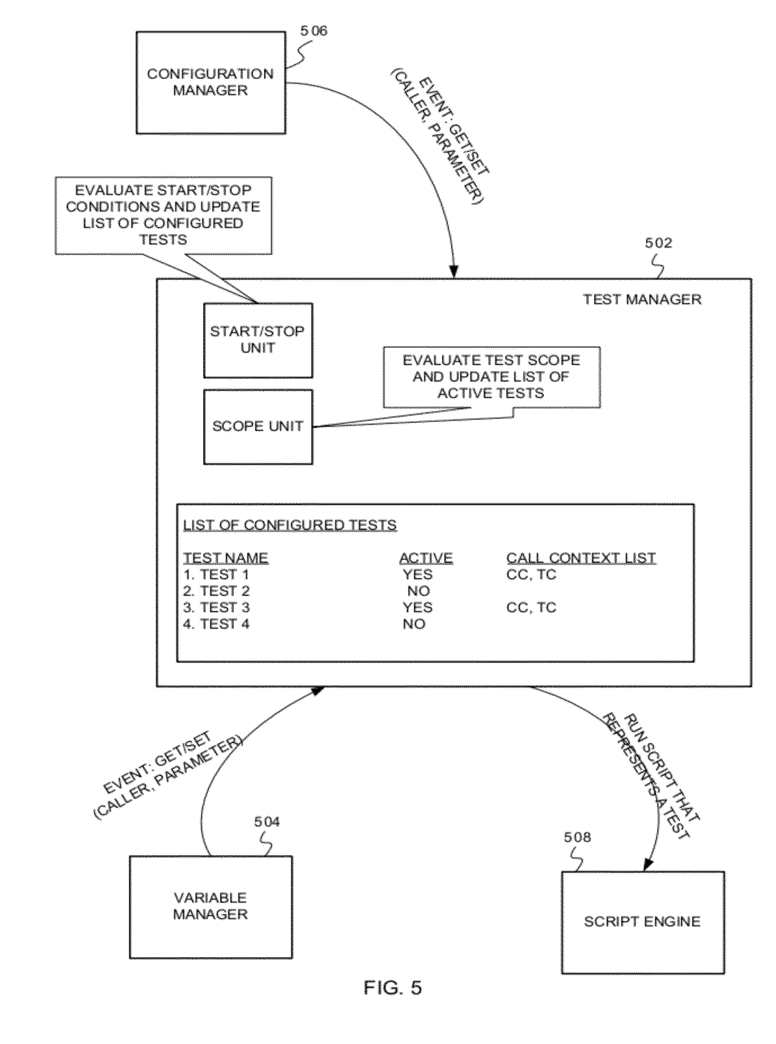

FIG. 5 describes components and operations for activating tests, according to some embodiments of the inventive subject matter. In FIG. 5, a test manager 502 receives events from a configuration manager 506, and the variable manager 504. The configuration manager 506 and variable manager 504 send events to the test manager 502 to indicate that other components in the connection agent have read or write parameters specified in the event. In some embodiments, the event indicates that a components has read (get) or written (set) a particular parameter or feature.

In some embodiments, the test manager 502 registers with the configuration manager 506 and variable manager 504 to receive such events. In some instances, the registration indicates which get/set calls the test manager 502 wants to receive. For example, the registration may indicate that the test manager is interested in get/set calls that involve certain feature sets, features, or attributes relating to network connectivity. As a result, the test manager 502 receives events when specific parameters have been read or written.

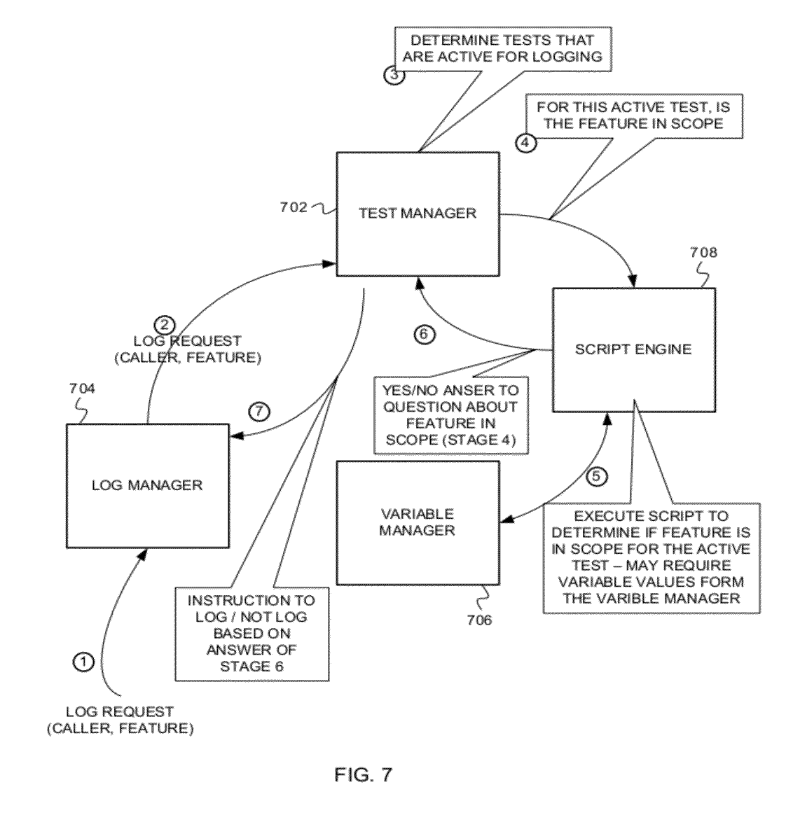

In some embodiments, as the test manager 502 receives events, it performs operations that cause tests to execute (e.g., execution of scripts that represent tests) and log requests to be evaluated. In some instances, events may cause the test manager to halt execution of test scripts. In some embodiments, the stream of events drives the test manager to perform logging. For example, in response to an event, the test manager 502 may instruct the log manager (not shown in FIG. 5) to record information in a log (e.g., see FIG. 7).

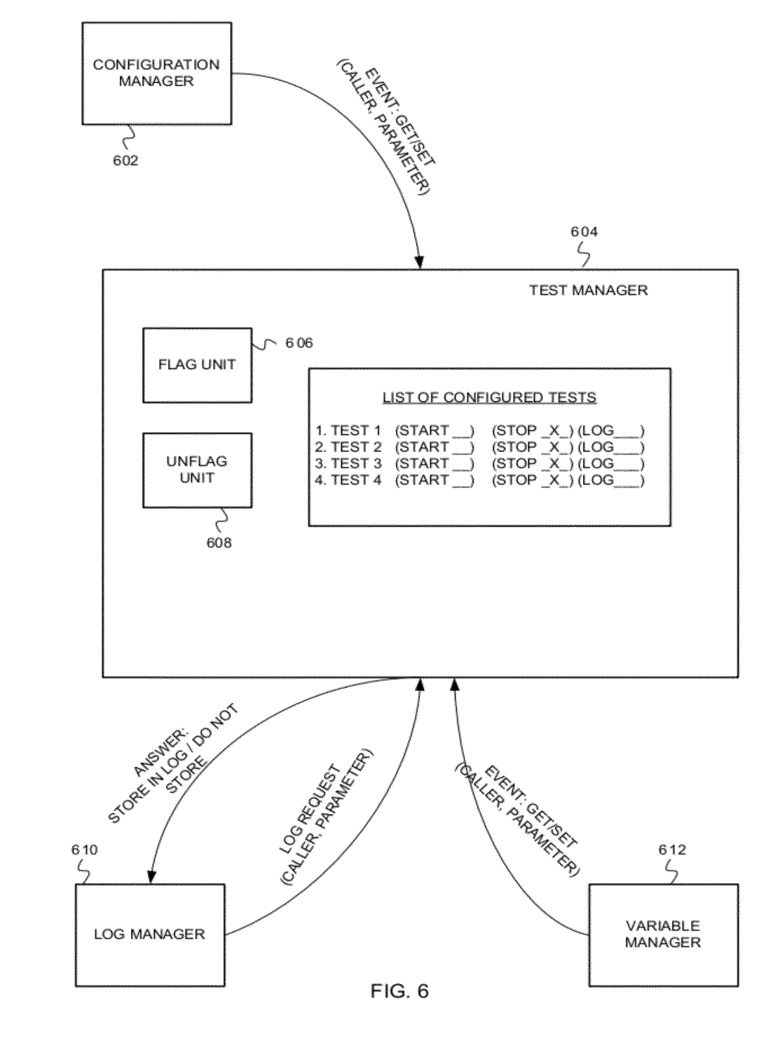

FIG. 6 is a block diagram showing event-triggered logging, as performed by some embodiments of the inventive subject matter. FIG. 6 shows some components of a connection agent including a configuration manager 602, test manager 604, log manager 610, and variable manager 612. The test manager 604 includes a flag unit 606 and an flag unit 608.

In FIG. 6, the test manager 602 receives events from the variable manager 612 and the configuration manager 602. The events indicate that components in the connection agent have read/written configuration options in the configuration manager or variables in the variable manager 612. The events may be associated with operations for connecting to a network, transmitting data over a network, or other operations formed by the connection agent.

The log manager 610 receives log requests and then queries the test manager about whether it (the log manager) should store information in the log requests. The test manager 604 will instruct the log manager 610 to store the information if the information is related to an active test, and the information is in scope for the active test (e.g., a variable related to a subroutine that is currently in scope in an active test script).

This description continues with a discussion of how some configuration agents perform a process for logging information for use in trouble shooting, diagnosing connection errors, etc.

FIG. 7 is a block diagram illustrating a process for logging, according to some embodiments of the inventive subject matter. The process includes seven stages of operations. During stage 1, the log manager 704 receives a request to log information. In some embodiments log request identifies the component sending the log request, and the parameter (variable, configuration option, feature, etc.) to be logged. Any suitable component in the connection agent can send log requests to the log manager 704.

During stage 2, the log manager forwards the log request to the test manager 702. During stage 3, the test manager determines tests that are active for logging. During stage 4, for the test manager's active tests, the test manager 704 queries the scripting engine to determine whether parameter is in scope. During stage 5, the script engine 708 executes a test script to determine whether the feature is in scope for the active test. In some instances, the script may read/write variables, so the script engine may ask for and receive variable values from the variable manager 706. During stage 6, the script engine 708 returns an answer (e.g., yes/no) about whether the feature is in scope. During stage 7, if the feature is in scope, the test manager instructs the log manager to log information associated with the log request. If the feature is not in scope, the test manager instructs log manager not to log information.

As a result, embodiments of the connection agent can ignore certain log requests that are not relevant to active tests.

### Addition Embodiments

As the total number of provisioned applications, provisioned elements (or features), unique profiles, or targeted users increases, so does its management complexity. Mistakes or omissions in the profile options, or in the sequence of change, deploy, test, verify, and re-test, generally results in poor user experience: unavailable applications, sub-optimal performance, features that won't work, and decreased reliability and productivity among others.

The ideas presented here can extend the centralized control framework to provision Profile Data to Provisioned Applications. These extensions can be centered on the following scenarios:
Initial configuration
Configuration Diagnostics
Configuration Test & Troubleshooting

The Initial configuration process can refer to the initial creation of the application profile. For the most part this can be a relatively straightforward process. However, there are a few features (such as VPN configuration, Campus Network Settings) that because of their configuration complexity can be error prone and could require several iterations to get it right.

The Configuration Diagnostics scenario can refer to a situation where a profile is incorrect (as can be manifested by an application not working properly) and the Admin needs more detailed information about the application's execution before it can pinpoint the change needed in the profile.

The Configuration Test & Troubleshooting scenario can refer to a situation where Admin wants to test the changes made to a profile before deploying it to its production audience.

This scenario can complement Configuration Diagnostics because here can be where the profile changes made can be verified for production deployment. And it can also be an extension of the Initial Configuration Scenario. While in an Initial Configuration scenario the focus can be on a standalone self-configuration of an application by an Admin user with little or no intervention from a Portal, in this one the focus can be on the Portal playing a more active role as the middleman in defining necessary tests, evaluation of results, and synchronization with 1 or more people actually performing tests.

In some embodiments, a provisioned application can be composed of the binaries installed in the target machine, and the provisioned data that provides specific values to parameters utilized by the application.

Reference Architecture in Appendix A shows an example provisioned data repository, a Web Portal that can expose a set of services for creating, querying, updating the repository. The administration UI can be a web application available via a web browser.

In this environment, the administrator could navigate through the options and menus corresponding to the features or options available for the application and sets its values to match the desired policy. When ready it could save the changes made in the database (http request).

Later on, the provisioned application can receive (push) or get (pull) the newly configured profile, install it in its working environment and start using it.

In some embodiments, if the profile is correctly configured then the application will behave as desired. Otherwise, the administrator will go back to the web UI make the necessary changes and repeat the process until things work as expected.

In some embodiments, this system focuses on making the iterative nature of producing and deploying correct profiles: develop, deploy, test, verify, re-test more efficient and less error prone. In some embodiments, the general strategy for this can include:
limiting the scope of the audience exposed to the test (group, user, or device)
limiting the scope of where and when is the test performed
applying profile operators that work on specific profile/feature and applies them to other profiles within same organization
provisioning of scripts that accomplish a specific test to prove a feature or to enumerate/probe specific variables or conditions that confirm a fix or a problem

This is described further in the following examples.

Typical Configuration—In some embodiments, the Admin creates a new profile on the Portal, and when completed, it then pushes it to its Production audience.

Initial Configuration—In some embodiments, a new profile is created in the Portal but there are several application features that the Administrator wants to configure from the Application itself, test it on the spot, and then upload to the portal when finished.

In some embodiments, once the changes are in the portal, they are subject to the Profile Change management life cycle. For example: the changes can be immediately accepted and deployed for Production or can be further reviewed, edited and tested before Production deployment. The Profile change management cycle is driven by the Admin and implemented by the Portal.

Profile Tracing or Troubleshooting—In some embodiments, a production profile needs fix because it fails when setting up a VPN at the German corporate site. The problem impacts users roaming from the US headquarters. The administrator knows how to fix the problem, however the solution entails changing the profile used by all US employees. The change must be tested at the German site and verified without impacting the rest of the users.

In some embodiments, updating the profile and deploying it to all US or German users and then monitoring the data collected to confirm the changes worked is not really an option.

In some embodiments, with this system the administrator in US can deploy a Test profile for a particular user or device, and a specific feature set (VPN in this case).

In some embodiments, the test profile will only be received by someone who is expecting it in a trial basis (the tester). It is deployed and installed to the target test device. The tester launches the provisioned application which automatically switches to “test mode” upon detecting that the profile is a Test profile.

In some embodiments, there are several variations on how the Administrator is notified of test outcomes: email, voice, text, or uploaded to OMP.

In some embodiments, the Administrator logs in to the portal and sees the test outcome: either positive confirmation that the fix work or detailed information on what went wrong.

In some embodiments, if the profile is still wrong, the administrator could make another change and re-deploy it to the same tester. This can be repeated multiple times until the fix works or until the Administrator stops and flags the issue as a desired but unsupported feature.

In some embodiments, if the profile is fixed, then it is marked for Production (if no other tests are pending) and distributed to all users sharing that US profile.

Profile Diagnostics—In some embodiments, the Administrator opens a ticket. Customer service provision a test script (or built-in expression) that gets evaluated within the context of the specific feature/feature set. The results of the evaluation along with descriptive traces of program execution are then presented to the test-user and/or uploaded to the test portal or emailed to Customer Service person.

In some embodiments, upon looking at the diagnostic output, customer service recommends a course of action including performing other tests.

Profile Verification—In some embodiments, IT Admin modifies the current profile to enable a new feature. Since this is something new, it wants to perform a test to validate the feature works as expected. This verification needs to happen without interfering with the activities of the current users nor requiring a massive profile update. Once happy with the results, it makes the profile available for distribution to all the users.

### Reference Data Model

Application—In some embodiments, represents the provisioned application

Profile—In some embodiments, represents a consistent set of data elements and its values that are or can be provisioned to a provisioned application.

Org Unit—In some embodiments, represents the organization unit to which users belong and for which a profile is created. The set of users so grouped constitute the audience of the profile.

User—In some embodiments, represents a registered user for the provisioned application.

Role—In some embodiments, represents a class of users from the context of this profile. Administrator, End-user, tester.

Feature Set—In some embodiments, represents a named set of features for a profile. Example: VPN Settings

Feature—In some embodiments, represents a named feature for a profile. Example VPN Cisco

Attribute—In some embodiments, represents specific attributes that collectively describe the Feature. Example VPN ini string.

Attribute value—In some embodiments, represents the value for a particular instance of the Attribute.

Tester—In some embodiments, the user(s) targeted for performing 1 or more tests.

Target device—In some embodiments, represents a named device(s) targeted for this test

Diagnostic Scripts—In some embodiments, represents the actual scripts associated with the test if any.

### Reference Architecture

In some embodiments, this architecture (see Appendix C), the provisioned application contains:

A Diagnostic Library. In some embodiments, this is a collection of pre-provisioned scripts (built-in or deployed by IT Admin).

Var Manager. In some embodiments, this component is a symbol table and an interface to the symbols it stores. Symbols are identified by name and can be read, written or used in the expression evaluation. An expression is described as a script.

Log Manager. In some embodiments, provides logging services to the rest of the application. It exposes an interface for the registration of logging contexts. A logging context is essence a Boolean function whose value is used to identify whether a given Log Record should printed or discarded. This Boolean function is represented as a script, and uses the Var Manager for symbol resolution and expression evaluation.

Test Manager. In some embodiments, this component loads the test specifications set by the IT Admin, registers handlers for Log Manager Events, and drives the evaluation of expressions and scripts.

Configuration Manager. In some embodiments, this component manages the configuration settings specified by the profile, exposes them to the Variable manager for its accessibility to scripting.

In some embodiments, a profile variable configured at the portal (standalone self-configuration) enables editing of specific profile section(s). The modified profile becomes active once the user saves the changes made. At this point the application is self-provisioned with the local changes and the user (an admin user) can test drive the application to confirm that the desired feature is properly configured. If so, the user uploads the modified profile to the portal from the application or exports it and then uploads it from the Portal itself In either case, the OMP will record the changes as a new profile version.

In some embodiments, the Provisioned application needs access to a Provisioning network and a Test network. The provisioning network provides access to the provisioning portal (OMP. The Test network provides the environment for performing the tests. We call out the 2 separately as to bring awareness that they don't need to be the same, and that a 2nd network is desirable to speed up the profile update, re-generation and status update cycle. Parallel access to the OMP facilitates this process. In the standalone mode, there is no need for simultaneous access to the 2 networks. The user can initially synchronize with the Portal to get the initial profile and at a later time or place it can perform the local modifications and test it with the target networks. Then at a later time and place it can upload the final configuration to the Portal.

A VM/Script Hosting component. In some embodiments, this component executes scripts that are provisioned as data. In other words they are a compilation unit that is separate from the host application. Examples of off-the shelf components that can do this include: a browser component, a Flash VM, and a Java VM. We refer to the code executed by this hosting component as a “script”.

### Functional Description

The following are the responsibilities of each component:

VM/Script hosting component. In some embodiments, performs two major functions: it allows local Viewing/Editing capabilities to the currently active profile, and it provides a runtime environment for the execution of scripts.

Front-end responsibilities can include: 1) View a profile in the same way as it would on the OMP but offline. 2) Edit a particular section(s) of the profile (Feature Set or Feature) by changing its options, selection and provisioned values. The IT Administrator determines which parts of the profile are editable at the application in this test context. This information in itself is also part of the profile. 3) Print-Generate the set of files (XML) representing the changes made in a particular section. These files are saved locally as data to its installation directory. These modified files could replace the ones originally provisioned from the OMP so that they can take effect on the application immediately (maybe a restart is needed). The ability to print-generate locally is also a separate attribute in the profile. 4) In some embodiments, these new files are flagged as locally generated causing the Application to switch to Test Mode. At the end of the test the user has the option of remaining in Test Mode (repeating a test, starting a new test), keeping them as final, or to restore to the original unmodified set of files. The modified files are also uploaded in the OMP since it contains the attributes settings that match the outcome. That is, if the outcome was that the test is successful, then the modified attributes should be propagated to the Production profiles via the OMP. 4) In some embodiments, if Print-Generate function is not allowed for this particular test scope, then the profile changes must be uploaded to the OMP for Print-Generation and download of the new set of provisioned files. However, one approach that can be used in this system is to define the Profile in terms of parameters that are user/domain/password-independent so that the locally modified configuration is still applicable to other users and then by having a runtime symbol substitution mechanism for those data items that are not directly applicable to other users, domains, platforms so that the actual value is determined at point-of-use. For example if the configured item is the user name/password, then the configuration profile will use a symbolic value like $USERNAME$ OR $PASSWORD_{—}1$ that is resolved to the current Open Mobile Client (OMC) user to something like user:scott, pwd:tiger.

Alternatively, the specification might indicate a particular process. For example setting the a profile attribute to $PROMPT$ will cause the OMC to prompt the user for input.

Configuration Manager. In some embodiments, it can have the following responsibilities: 1) To provide a single point of use, change and control of any data element in the profile. 2) To exposes a set/get interface to read to write any of the named attributes of the profile. 3) When in test mode, the Configuration Manager notifies the Test Manager (event/callback) if the get/set falls within the registration criteria specified by the Test Manager. When it does it generates an event that is used by the Test Manager to delineate the areas of activation for performing the matching test. And by the Log Manager to determine whether a log entry can be ignored, whether a registered test script needs to be evaluated. 4) Uses the VAR Manager for the storage, retrieval and sharing of configuration attributes. 5) Manages Test specifications, trials, outcomes, synchronization with OMP.

Test Manager. In some embodiments, it can have the following responsibilities: 1) Determines the test scope and definitions for the current Profile by querying the Configuration Manager. 2) Registers Test Manager with Log Manager 3) Registers Named Test with Log Manager.

In some embodiments, Test Specification includes test's start/stop expressions.

Also see Log Manager.

In some embodiments, the Start Condition is a Boolean expression that indicates whether the test is valid/active/enabled.

In some embodiments, the Stop Condition is a Boolean expression that indicates whether the test is invalid/inactive/disabled. When it becomes true, it will call the Test-Complete method. By default, this is a comparison expression based on the caller prefix context, named thread, service or log category. The Log Manager Queries this result and ANDs it together with test specific conditions as defined for that test.

In some embodiments, the start/stop conditions are evaluated on demand by the Test Manager whenever a change in the Variable Mgr takes place or when a Log Entry request is received by the Log Manager.

In some embodiments, a caller prefix context represents the call stack, all the way down to the named procedure encapsulating the place in the code where a particular function or method is called. For example (main:A:B) indicates the activation path from main program followed by a call to Sub A, then Sub B. Comparisons based on regular expressions allows for detecting special cases like recursion.

In some embodiments, in a particular context, the test manager compares the Caller Prefix(es) of the current test (i.e. the set of 1 or more get/set operations registered from the Configuration Manager) against the Caller Prefix(es) of the place where the Log entry call takes place (i.e. place where log entry method in log manager is called in OMP).

Registers a specific test id with the Configuration Manager to get notified whenever an access request (Get/Set) falls within this test scope.

Test scope is a named Feature Set, Feature or attribute.

The test manager associates the attribute that trigger the notification, along with its calling context and makes it available during evaluation of the start/stop conditions.

Registers Trace test with Log Manager (See Log Manager).

In essence the registration request includes a within-scope condition. When this condition evaluates to true AND the test is enabled then the Log Manager will consider future Log Entry requests as falling within the scope of this test. The Test Manager will then receive the corresponding data streams.

Registers Verification test with Log Manager.

See Log Manager.

Registers Diagnostic test with Log Manager.

See Log Manager.

Receives requests from the OMC as to whether the named test is Completed Test-Complete method (Finished, Terminated, and Aborted). This will force the status to be set to complete regardless of the stop condition.

Test status will be updated, persisted, and if the test is configured for manual verification, also cause the user to be prompted for the outcome of the test: Pass, Fail, Or Inconclusive.

Requests the Log Manager to stop streaming Log Records.

The Log Manager, will by default stop streaming records when the scope condition is no longer met. However, the Test Manager can explicitly request to do so.

Keeps track of current status and history of tests performed, its corresponding output, verification outcomes, and diagnostic tests.

Interacts with the end-user to determine when it is time to revert from Test mode, the outcome of the test, the edited/final values that must be pushed back to the OMP for its incorporation into the production profile, updates the profile and test status and results to the OMP.

The Log Manager can have the following responsibilities:

Receives log entry requests from anywhere in the compilation unit

Requests will contain a category, level, message code, message text.

Handles Test Manager Registration Request from Test Manager

Request will include an indication of Test Mode, and a package of functions/scripts that must be loaded to the Diagnostic Library and made available as the run-time environment for the any expressions, conditions, scripts evaluation or execution while this registration remains active. Typically, the Test Manager will remain registered until OMC exits or until explicitly de-registered when performing profile transitions such as reverting to Production profile, applying test profile, or applying in-line profile changes/tests.

Handles Test Registration requests from Test Manager.

Request will contain the test id, notification spec, start condition, stop condition.

The Notification Spec is either an event or callback, and indicates how the Test Manager will be notified of log output, and results of this test.

The Start/Stop conditions are Boolean expressions that would enable/disable this test. Test capture and execution is allowed only while the test is enabled.

Handles Trace Registration requests from Test Manager

Request will contain a test id, and a scope specification.

The scope specification is a Boolean expression that when it returns true it indicates that the log record is within the scope of this active test. Scope specification will typically include a caller context prefix matching as a way to automatically make out/in scope determinations.

Handles Verification Registration requests from Test Manager.

Request is composed of a test id, test specification, test condition, and a test result.

The test specification is a script that represents an expression that is evaluated by the VM/Host component or Variable Manager. The output of this generates 1 or more log entries and processed accordingly. Verification functions are Boolean functions that can be associated with a test semantic category. For example: A success test will return true when the verification is successful; A failure test returns true when the verification has failed.

The test condition is an expression that represents a further constraint on when the expression will be evaluated. After all the test scopes had been applied, and the test condition is true then the expression is evaluated. This test condition expression will typically use built-in variables from the Var Mgr such as Connection Lifecycle States (Pre-Connect, Connecting, Connected)

The result of the expression(s) is/are returned to the Test Manager correlated with its Log Record in the Log stream (special field in the event or callback or in a separate stream with a Log record id).

Handles Diagnostic Registration requests from Test Manager

Request is composed of a test id, test specification, test condition, output spec, and a test result Spec.

Test Specification. The test is specified by the actual script. The script itself is sent for execution to the VM/Hosting component. The script uses any syntactic feature available to the language including a set of built-in diagnostic functions built-in within OMC (Diagnostic Library). The purpose of the Diagnostic Script is to perform operations such as checking program variables, network state (when a condition is met) and funneling the resulting output to the log file. This steps are steps that would not normally be part of the normal execution of the Application and also produce more detailed information about Application State that would otherwise be logged.

Test Condition. This is a Boolean expression that triggers the execution of this test when evaluated to true. The expression is defined in terms of operators and predicates available to the VM/Hosting component. Test conditions are evaluated by the Variable Manager and triggered by changes in values of symbols (or variables) within its scope. A test might be triggered multiple times within the span of the test id. The test manager, will store, maintain, of all the data (log, output, results) for activation of this diagnostic test.

Output Spec. Any output consequence of this script is sent directly to the log file or reported to the Test Manager via event or callback.

Test Result Spec. This is the result returned by the diagnostic script. It is reported to the Test Manager via event or callback upon its completion.

For any log request received (from anywhere in the compilation unit) it determines whether the current Log Context (i.e. the caller prefix of call to log an entry) is within the scope requested by the Test Manager. If so, it notifies the Test Manager in addition to the regular log processing. Otherwise Test Manager is not notified and regular log processing takes place.

The OMP can have the following responsibilities:

Provides transactional support for the Creation, Management, Updates, Print/Generation of Provisioning data, and its distribution/download to clients.

Some of its functions like Edit/View/Print-Generate operations are implemented in the hosted language for its export to the Provisioned Application. This provides a single physical implementation that can execute either at the OMP or at the OMC.

GUI and API for the upload of profile changes, test status, output and results for a given profile and the setting of the next action: Incorporate Profile Changes and Retest/Close, Ignore Profile Changes and Retest/Close.

Profile Merge Operations.

When profiles are deemed correct then it makes sense to copy and paste them to other profiles. Any of the attributes in the profile context (part of the Profile Entity) are suitable as targeting criteria. For all those profiles that match, then settings for the target feature set/feature are transferred over from the source profile. For example: The VPN Settings feature set from profile 123 (along with all its Features and Attributes) will be copied to attributes 2,4,6 that match the criteria of being for the same customer id, same platform (Windows Vista), and same version (OMC 1.3).

The OMC can have the following responsibilities:

Call the get/set methods to use Profile's feature attributes. Ideally this should be as close as possible to its point of use but not required.

Call the Test Manager Test-Complete method whenever the end-user indicates so or before the OMC is shutting down.

Instantiate the VM/Hosting component and provide a GUI environment for the display/edit/print of the test profile.

If the profile is editable from within OMC, then the provisioning files are also re-generated and reloaded. And the new values will take effect upon OMC re-initialization. Comparisons among tests are possible because OMC starts at the same known state before test functions are executed.

For those operations and features for which Print-Generation of the profile or provisioned files is not possible, the interaction with OMP will be necessary. Use of a 2nd network might be desirable for ease of test since interaction with OMP can take place on the test tour.

Provide a GUI for the Evaluation by end-user if so configured and Data/Status Upload to OMP.

### Determination of Test Scope

In some embodiments, the scope of a given test can be determined in 2 ways: either explicitly via release (attribute) call to the configuration manager from anywhere in the OMC application, or automatically via the start/stop conditions that get evaluated by the Log Manager each time that there is a new log entry.

In some embodiments, a call context list (CCM) object is allocated and managed by the Test Manager. There is one CCL allocated for each Active Test. A CCL entry represents the pair <CC, TC> where: 1) CC=Caller Context<Process Id, Thread Id, Call Stack String> and 2) TC=Test Context<Test Id, Attribute, Feature, Feature Set>

In some embodiments, the VM/Hosting component provides one or more built-in operators that can be utilized as predicates in Start/Stop Conditions for a Test instance. The following operators, functions and their semantics can be identified within this system:

Operator: Active(TC), Semantics—Returns true iff there is an entry in CCL for Test Context.

Operator: Active (CC,TC), Semantics—Returns true iff there is an entry that is a prefix of CC for this Test Context.

Operator: Put(CC, TC), Semantics—Adds an entry to CCL only if there is No CCL entry with matching CC, TC A CCL entry with matching TC, and its Call Stack string is a prefix.

Operator: Flush(ProcessId, ThreadId)—Semantics Removes all CCL entries for Process Id, Thread Id.

Operator: Flush(CC, TC)Removes CCL entry for hierarchical match of Test Context and call prefix.

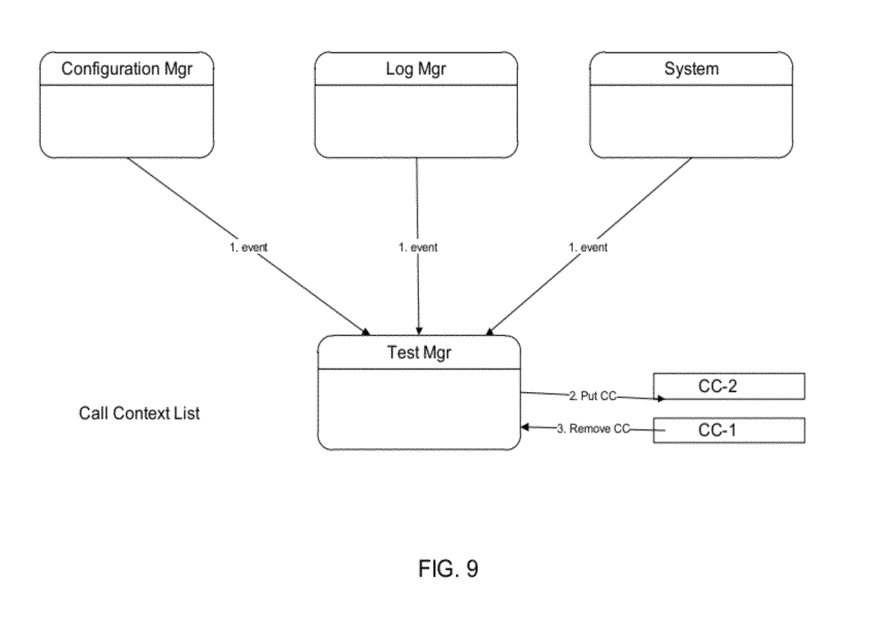

FIG. 9 is a diagram showing a CCL list for one test and currently with two entries (CC1 and CC2). Test Manager receives events (1) from Configuration Manager, Log Manager, and System for which it has registered falling within the test scope. The Test Manager adds (2) corresponding entry to the CCL. When the Test exits its scope then the corresponding entry is removed (3).

### Deployment Scenarios

Configuration Viewing/Editing Technology

In some embodiments, in this system, the data content of the configuration profile constitutes an interface specification by which profiles written by the OMP can be understood by the OMC and the other way around.

However, in some embodiments, this system identifies to possible deployment scenarios: one in which the visualization/editing component (which is a sub-component of the VM/Host component) is implemented in a language that is readily supported at both the OMP and OMC. A benefit of this deployment is the reusability of this component (implement once, deploy many) and its flexibility of update because the component itself can be dynamically updated without requiring recompilation of the OMC.

The 2nd deployment scenario constitutes the case where the visualization/editing component is not shared between OMP and OMC. In some embodiments, this variation requires multiple implementations for the visualization/editing component: in this case one for the OMP and one for the OMC. Benefits of this variation include: ability for the OMP and OMC to pick the rendering/editing technology that is most appropriate for its computing platform. And its extensibility to other platforms: For example: Adobe Flash is available in Windows but not in iPhone OS;

### Standalone vs. Collaborative

In some embodiments, In a standalone mode, an OMC user can view, edit, apply, and run the application without any dependencies whatsoever from OMP. The user can then plan ahead and synchronize the initial configuration, perform the modification and tests, and upload the final configuration and different times and locations to match the network availability or to account for location dependencies. For example: initial OMP and test network are mutually exclusive location-wise.

In some embodiments, in a collaborative mode, once the profile changes are uploaded to the OMP, another admin user at another time and location can validate the results (for example iRoam in Redwood Shores vs. Bangalore) by continuing where the first admin left off.

In some embodiments, this system is suitable for switching between Standalone and

### Collaborative Modes. Sample of Profile Viewing/Editing in OMC

Many features can be setup this way. In some embodiments, features which are intrinsically complex to configure are top candidates for self-configuration. Some features include: Campus Networking, VPN, and Third party applications with complex command line.

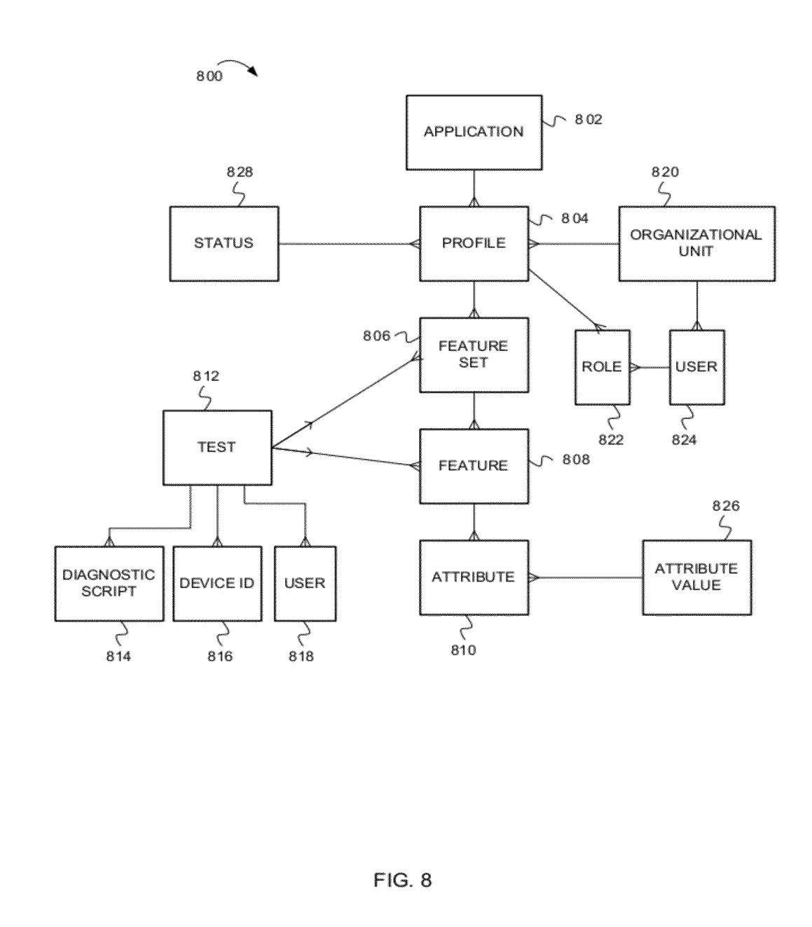

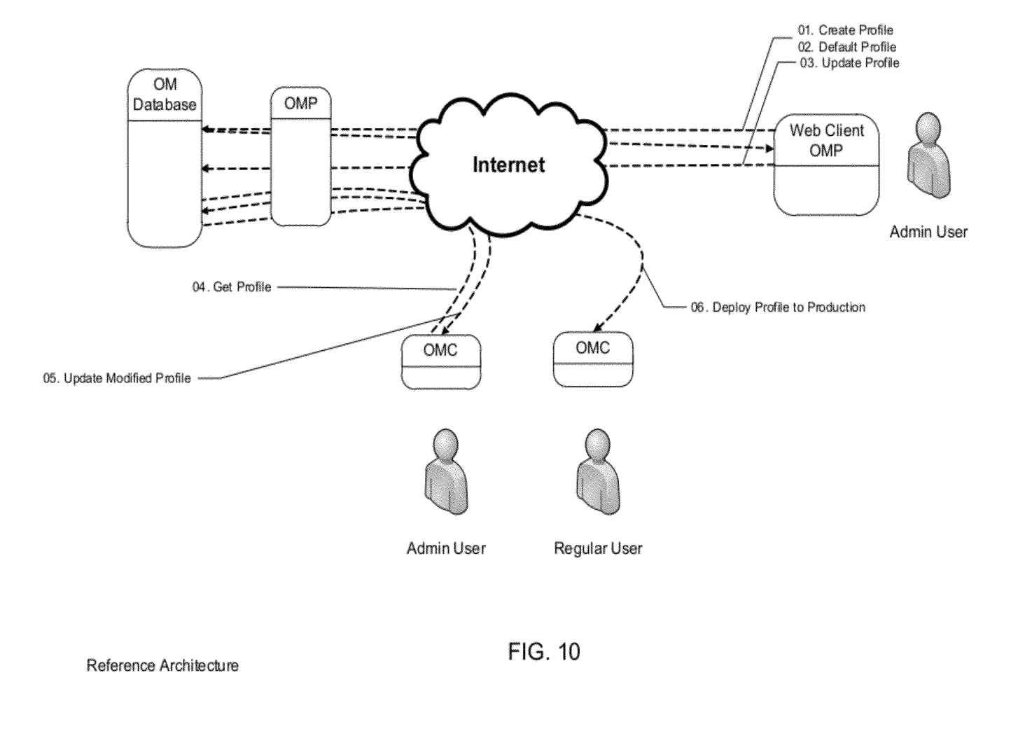

FIG. 8 is a block diagram of a data model used in connection with some embodiments. FIG. 10 shows an alternative architecture, according to some embodiments.

### General

This description describes numerous details about embodiments of the invention. However, some embodiments may be practiced without these specific details. In some instances, for sake of clarity, this description omits well-known circuits, structures and techniques. In this description, references to “one embodiment” or “some embodiments” mean that a feature is included in at least one embodiment of the invention. Furthermore, separate references to “some embodiments” do not necessarily refer to the same embodiments. Thus, the present invention can include any combination the embodiments described herein.

1. A method comprising:
detecting, in a connection agent, a problem connecting to a network;
receiving, in the connection agent, replacement configuration options, wherein the replacement configuration options are for updating a configuration profile for the connection agent; wherein the configuration profile for the connection agent and the replacement configuration options define parameter values used in connecting to a network;
updating the configuration profile for the connection agent based on the replacement configuration options; and
determining, using testing components in the connection agent, test results that indicate the replacement configuration options do not solve the problem connecting to the network.

2. The method of claim 1 further comprising:
notifying a provisioning service of the test results.
receiving additional replacement configuration options for updating a configuration profile for the connection agent;
updating the configuration profile for the connection agent based on the additional replacement configuration options; and
determining, using the testing components in the connection agent, additional test results that indicate the additional replacement configuration options solve the problem connecting to the network;
notifying the provisioning service of the additional test results.

3. The method of claim 2 further comprising:
creating, at the provisioning server, a new configuration profile matching the configuration profile for the connection agent;
distributing the new configuration profile to other configuration agents.

4. The method of claim 1, wherein the testing components include test scripts configured for execution by the connection agent and to create the test results.

5. A system comprising:
a provisioning service configured to
receive input indicating selected configuration options for a connection agent, wherein the configuration options define parameter values for use in connecting to a network;
transmit the configuration options to the connection agent;
the connection agent including
a configuration manager configured to receive the configuration options;
a connection unit configured to connect to the network based on the configuration options;
a test manager configured to cause execution of test scripts that perform tests, wherein the tests verify proper operation of the connection agent under the configuration options, wherein the connection agent is also configured to transmit a notification to the provisioning service about the verification of proper operation; and
a log manager configured to log information associated with the tests.

6. The system of claim 5, wherein the provisioning service is further configured to receive the notification about the verification of proper operation, and to distribute the configuration options to a group of configuration agents after receipt of the notification.

7. The system of claim 5, wherein the test manager is further configured to receive events from the configuration manager and the log manager, wherein some of the events trigger the execution of the test scripts.

8. The system of claim 7, wherein the test manager is further configured to
receive, from the log manager, log request events; and
instruct, in response to the log request events, the log manager whether to write information in a log.
